(19) United States
(12) Patent Application Publication
(10) Pub. No.: US 2026/0340085 A1
(43) Pub. Date: Oct. 29, 2026

(54) SYSTEM AND A METHOD FOR AGENTIC CORRECTION OF DATA CLASSIFICATION FINDINGS

(71) Applicant: Veeam, San Jose, CA (US)

(72) Inventors: Michael David Rinehart, Pleasanton, CA (US); Michael Busha, Menlo Park, CA (US); Rehan Jalil, Portola Valley, CA (US)

(21) Appl. No.: 19/655,921

(22) Filed: Apr. 23, 2026

Related U.S. Application Data
(60) Provisional application No. 63/793,365, filed on Apr. 23, 2025.

(51) Int. Cl. G06F 18/24; G06F 16/907; G06F 18/2413

(52) U.S. Cl. CPC G06F 18/24765; G06F 16/907; G06F 18/2413

(57) ABSTRACT

A system and a method for agentic correction of data classification findings is provided. The system includes hardware processor and memory coupled to hardware processor. Memory comprises program instructions forming processing subsystem hosted on server and configured to execute on network for controlling bidirectional communications among modules. Processing subsystem includes finding ingestion module configured to receive findings from external scanning systems via application programming interface or data store, wherein findings comprise data elements, initial classifications, confidence scores, and metadata. Data scanning module identifies and classifies data elements based on rules or patterns. Finding retriever module selects findings and filters findings associated with pending update or previously updated. Context retriever module retrieves contextual data. Agentic classification module analyses findings and generates updated classifications. Orchestrator module controls classification stages. Learning module generates classifiers. Similarity search module identifies similar findings. Automatic application module updates classifications. Output integration module transmits updates.

### FIELD OF INVENTION

Embodiments of the present disclosure relate to a field of data classification systems and more particularly to a system and a method for agentic correction of data classification findings.

### BACKGROUND

Modern data classification systems face a fundamental challenge: balancing accuracy with computational efficiency when processing large volumes of structured and unstructured data. Traditional approaches typically employ either high-speed, low-accuracy methods for bulk processing, or computationally intensive, high-accuracy methods for detailed analysis. However, these approaches lack the intelligence to dynamically adapt their resource allocation based on the complexity of individual classification tasks.

Existing systems suffer from several limitations: Static Resource Allocation: Current systems apply uniform computational effort regardless of classification difficulty, leading to inefficient resource usage where simple cases receive excessive processing and complex cases receive insufficient attention. Limited Context Utilization: Traditional classifiers analyse data elements in isolation, failing to leverage contextual relationships that could significantly improve accuracy (e.g., other columns in the same database table, similar data patterns across the system). Lack of Autonomous Learning: Most systems require manual tuning and rule updates, lacking the ability to automatically learn from classification corrections and apply these learnings to improve future performance. Inflexible Processing Models: Existing approaches typically use fixed single-stage processing that cannot dynamically adapt computational effort or escalate between different levels of analysis based on case complexity.

Ineffective Pattern Generalization: When corrections are made, these systems fail to extract generalizable patterns that could be applied to similar cases, requiring repeated manual intervention for comparable classification errors. Isolated Operation: Existing systems typically operate in isolation, lacking the ability to integrate with and improve the performance of external scanning systems such as data loss prevention (DLP) tools, data discovery platforms, and compliance monitoring systems that may have identified the same or related classification issues. Limited Human-Computer Interaction: Current systems lack sophisticated interfaces for incorporating human expertise and guidance into the classification process, failing to leverage human domain knowledge to improve automated classification decisions. Inadequate LLM Integration: While large language models (LLMs) offer unprecedented classification capabilities, existing systems fail to effectively integrate these advanced AI technologies into practical, scalable classification workflows. The increasing volume and complexity of data, combined with the need for real-time or near-real-time classification accuracy, creates a long-felt need for an intelligent system that can autonomously adapt its processing approach based on case complexity while continuously learning and improving its performance across multiple integrated systems

Hence, there is a need for an improved system and method for agentic correction of data classification findings that addresses the aforementioned issue(s).

### OBJECTIVE OF THE INVENTION

A primary objective of the invention is to provide a system and a method configured for agentic correction of data classification findings by maintaining a cryptographically secured block-chained conversation history that ensures ordered continuity and tamper-evident integrity across a plurality of conversation entries.

A primary objective of the invention is to provide a system that automatically corrects data classification findings received from one or more external scanning systems by leveraging agentic artificial intelligence models capable of contextual and semantic analysis.

Another objective of the invention is to provide a system that identifies misclassified findings and applies contextual information, including similarity-based and structural relationships, to improve classification accuracy without requiring manual rule updates or rescanning of source data.

Yet another objective of the invention is to provide a system that learns from classification corrections by extracting reusable classification patterns and generating classifiers that can be applied to similar findings for automated bulk correction.

Yet another objective of the invention is to provide a system that integrates with existing data classification infrastructures and automatically updates classification results or corresponding finding statuses, including identifying false positives, thereby improving operational efficiency and scalability.

### BRIEF DESCRIPTION

In accordance with an embodiment of the present disclosure, a system for agentic correction of data classification findings is provided. The system includes a hardware processor, and a memory coupled to the hardware processor. The memory comprises a set of program instructions in the form of a processing subsystem hosted on a server and configured to execute on a network to control bidirectional communications among a plurality of modules. The processing subsystem includes a finding ingestion module. The finding ingestion module configured to receive a plurality of findings from one or more external scanning systems via at least one of an application programming interface or a data store, wherein the plurality of findings comprise data elements, corresponding initial classifications, optional confidence scores, and associated metadata. The processing subsystem includes a data scanning module operatively coupled to the finding ingestion module. The data scanning module is configured to identify and classify the data elements of the plurality of findings based on one or more rules or patterns, wherein the data elements comprise substrings within documents, structured fields, or larger data units. The data scanning module is configured to classify the data elements using techniques comprising pattern matching, regular expressions, and statistical analysis such that the plurality of findings include the data elements and the associated metadata. The processing subsystem includes a finding retriever module operatively coupled to the finding ingestion module. The finding retriever module is configured to select one or more findings from the plurality of findings based on at least one of the optional confidence scores, classification types, historical error patterns, or predefined selection criteria. The finding retriever module is configured to filter out the one or more findings that are associated with a pending update and that have been previously updated. The processing subsystem includes a context retriever module operatively coupled to the finding retriever module. The context retriever module is configured to retrieve a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships. The processing subsystem includes an agentic classification module operatively coupled to the context retriever module. The agentic classification module comprises at least one large language model, one or more specialized language models, or one or more machine learning models. The agentic classification module is configured to analyse the one or more findings based on the contextual data. The agentic classification module determines whether an initial classification corresponding to each of the one or more findings is correct, incorrect, or uncertain. The agentic classification module is configured generate one or more updated classifications corresponding to the one or more findings. The processing subsystem includes an orchestrator module operatively coupled to the finding retriever module, the context retriever module, and the agentic classification module. The orchestrator module is configured to control execution of a plurality of classification stages. The orchestrator module is configured to route the one or more findings between the plurality of classification stages based on at least one of confidence values associated with the one or more findings or classification characteristics associated with the one or more findings. The processing subsystem includes a learning module operatively coupled to the agentic classification module. The learning module is configured to extract one or more classification patterns from the one or more updated classifications. The learning module is configured to generate at least one targeted classifier or at least one general classifier based on the one or more classification patterns. The learning module is configured to identify one or more similar findings based on at least one of similarity search or clustering. The learning module is configured to construct the at least one targeted classifier or the at least one general classifier based on the one or more similar findings. The processing subsystem includes a similarity search module operatively coupled to the learning module. The similarity search module comprises a vector database configured to store a vector representations corresponding to the plurality of findings, the contextual data, and the at least one targeted classifier or the at least one general classifier. The similarity search module configured to identify the one or more similar findings based on similarity metrics. The processing subsystem includes an automatic application module operatively coupled to the learning module and the similarity search module. The automatic application module is configured to apply the at least one targeted classifier or the at least one general classifier to automatically update classifications of additional findings corresponding to the one or more similar findings. The processing subsystem includes an output integration module operatively coupled to the agentic classification module and the automatic application module. The output integration module is configured to transmit the one or more updated classifications to the one or more external scanning systems and to update a corresponding status of the one or more findings.

In accordance with another embodiment of the present disclosure, a method for agentic correction of data classification findings is provided. The method includes receiving a plurality of findings from one or more external scanning systems via at least one of an application programming interface or a data store, wherein the plurality of findings comprise data elements, corresponding initial classifications, optional confidence scores, and associated metadata. The method includes identifying and classifying the data elements of the plurality of findings based on one or more rules or patterns, wherein the data elements comprise substrings within documents, structured fields, or larger data units. The method includes classifying the data elements using techniques comprising pattern matching, regular expressions, and statistical analysis such that the plurality of findings include the data elements and the associated metadata.

The method includes selecting one or more findings from the plurality of findings based on at least one of the optional confidence scores, classification types, historical error patterns, or predefined selection criteria. The method includes filtering out the one or more findings that are associated with a pending update and that have been previously updated. The method includes retrieving a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships. The method includes analysing the one or more findings based on the contextual data, wherein one or more artificial intelligence and machine learning models comprising at least one large language model, one or more specialized language models, or one or more machine learning models. The method includes determining whether an initial classification corresponding to each of the one or more findings is correct, incorrect, or uncertain. The method includes generating one or more updated classifications corresponding to the one or more findings. The method includes controlling execution of a plurality of classification stages. The method includes routing the one or more findings between the plurality of classification stages based on at least one of confidence values associated with the one or more findings or classification characteristics associated with the one or more findings. The method includes extracting one or more classification patterns from the one or more updated classifications. The method includes generating at least one targeted classifier or at least one general classifier based on the one or more classification patterns. The method includes identifying one or more similar findings based on at least one of similarity search or clustering. The method includes constructing the at least one targeted classifier or the at least one general classifier based on the one or more similar findings. The method includes storing a vector representations corresponding to the plurality of findings, the contextual data, and the at least one targeted classifier or the at least one general classifier. The method includes identifying the one or more similar findings based on similarity metrics. The method includes applying the at least one targeted classifier or the at least one general classifier to automatically update classifications of additional findings corresponding to the one or more similar findings. The method includes transmitting the one or more updated classifications to the one or more external scanning systems and to update a corresponding status of the one or more findings.

In accordance with another embodiment of the present disclosure, a non-transitory computer-readable medium storing a computer program that, when executed by a processor, causes the processor to perform a method for agentic correction of data classification findings is provided. The method includes receiving a plurality of findings from one or more external scanning systems via at least one of an application programming interface or a data store, wherein the plurality of findings comprise data elements, corresponding initial classifications, optional confidence scores, and associated metadata. The method includes identifying and classifying the data elements of the plurality of findings based on one or more rules or patterns, wherein the data elements comprise substrings within documents, structured fields, or larger data units. The method includes classifying the data elements using techniques comprising pattern matching, regular expressions, and statistical analysis such that the plurality of findings include the data elements and the associated metadata. The method includes selecting one or more findings from the plurality of findings based on at least one of the optional confidence scores, classification types, historical error patterns, or predefined selection criteria. The method includes filtering out the one or more findings that are associated with a pending update and that have been previously updated. The method includes retrieving a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships. The method includes analysing the one or more findings based on the contextual data, wherein one or more artificial intelligence and machine learning models comprising at least one large language model, one or more specialized language models, or one or more machine learning models. The method includes determining whether an initial classification corresponding to each of the one or more findings is correct, incorrect, or uncertain. The method includes generating one or more updated classifications corresponding to the one or more findings. The method includes controlling execution of a plurality of classification stages. The method includes routing the one or more findings between the plurality of classification stages based on at least one of confidence values associated with the one or more findings or classification characteristics associated with the one or more findings. The method includes extracting one or more classification patterns from the one or more updated classifications. The method includes generating at least one targeted classifier or at least one general classifier based on the one or more classification patterns. The method includes identifying one or more similar findings based on at least one of similarity search or clustering. The method includes constructing the at least one targeted classifier or the at least one general classifier based on the one or more similar findings. The method includes storing a vector representations corresponding to the plurality of findings, the contextual data, and the at least one targeted classifier or the at least one general classifier. The method includes identifying the one or more similar findings based on similarity metrics. The method includes applying the at least one targeted classifier or the at least one general classifier to automatically update classifications of additional findings corresponding to the one or more similar findings. The method includes transmitting the one or more updated classifications to the one or more external scanning systems and to update a corresponding status of the one or more findings.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for agentic correction of data classification findings in accordance with an embodiment of the present disclosure;

FIG. 2 is a schematic representation of an exemplary embodiment of the system of FIG. 1, in accordance with an embodiment of the present disclosure;

FIG. 3 is a block diagram of a computer or a server in accordance with an embodiment of the present disclosure;

FIG. 4 is a schematic diagram illustrating an operational flow and integration of the system of FIG. 1 with external systems, in accordance with an embodiment of the present disclosure; and

FIG. 5a is a flow chart representing the steps involved in a method for agentic correction of data classification findings in accordance with an embodiment of the present disclosure;

FIG. 5b is a flow chart representing the continued steps involved in a method of FIG. 5a, in accordance with an embodiment of the present disclosure;

FIG. 5c is a flow chart representing the continued steps involved in a method of FIG. 5b, in accordance with an embodiment of the present disclosure; and

FIG. 5d is a flow chart representing the continued steps involved in a method of FIG. 5c, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms "comprises", "comprising", or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by "comprises... a" does not, without more constraints, preclude the existence of other devices, sub-systems, elements, structures, components, additional devices, additional sub-systems, additional elements, additional structures, or additional components. Appearances of the phrase "in an embodiment", "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for agentic correction of data classification findings. The system includes a hardware processor, and a memory coupled to the hardware processor. The memory comprises a set of program instructions in the form of a processing subsystem hosted on a server and configured to execute on a network to control bidirectional communications among a plurality of modules. The system includes a hardware processor, and a memory coupled to the hardware processor. The memory comprises a set of program instructions in the form of a processing subsystem hosted on a server and configured to execute on a network to control bidirectional communications among a plurality of modules. The processing subsystem includes a finding ingestion module. The finding ingestion module configured to receive a plurality of findings from one or more external scanning systems via at least one of an application programming interface or a data store, wherein the plurality of findings comprise data elements, corresponding initial classifications, optional confidence scores, and associated metadata. The processing subsystem includes a data scanning module operatively coupled to the finding ingestion module. The data scanning module is configured to identify and classify the data elements of the plurality of findings based on one or more rules or patterns, wherein the data elements comprise substrings within documents, structured fields, or larger data units. The data scanning module is configured to classify the data elements using techniques comprising pattern matching, regular expressions, and statistical analysis such that the plurality of findings include the data elements and the associated metadata. The processing subsystem includes a finding retriever module operatively coupled to the finding ingestion module. The finding retriever module is configured to select one or more findings from the plurality of findings based on at least one of the optional confidence scores, classification types, historical error patterns, or predefined selection criteria. The finding retriever module is configured to filter out the one or more findings that are associated with a pending update and that have been previously updated. The processing subsystem includes a context retriever module operatively coupled to the finding retriever module. The context retriever module is configured to retrieve a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships. The processing subsystem includes an agentic classification module operatively coupled to the context retriever module. The agentic classification module comprises at least one large language model, one or more specialized language models, or one or more machine learning models. The agentic classification module is configured to analyse the one or more findings based on the contextual data. The agentic classification module is configured determine whether an initial classification corresponding to each of the one or more findings is correct, incorrect, or uncertain. The agentic classification module is configured generate one or more updated classifications corresponding to the one or more findings. The processing subsystem includes an orchestrator module operatively coupled to the finding retriever module, the context retriever module, and the agentic classification module. The orchestrator module is configured to control execution of a plurality of classification stages. The orchestrator module is configured to route the one or more findings between the plurality of classification stages based on at least one of confidence values associated with the one or more findings or classification characteristics associated with the one or more findings. The processing subsystem includes a learning module operatively coupled to the agentic classification module. The learning module is configured to extract one or more classification patterns from the one or more updated classifications. The learning module is configured to generate at least one targeted classifier or at least one general classifier based on the one or more classification patterns. The learning module is configured to identify one or more similar findings based on at least one of similarity search or clustering, and construct the at least one targeted classifier or the at least one general classifier based on the one or more similar findings. The processing subsystem includes a similarity search module operatively coupled to the learning module. The similarity search module comprises a vector database configured to store a vector representations corresponding to the plurality of findings, the contextual data, and the at least one targeted classifier or the at least one general classifier. The similarity search module configured to identify the one or more similar findings based on similarity metrics. The processing subsystem includes an automatic application module operatively coupled to the learning module and the similarity search module. The automatic application module is configured to apply the at least one targeted classifier or the at least one general classifier to automatically update classifications of additional findings corresponding to the one or more similar findings. The processing subsystem includes an output integration module operatively coupled to the agentic classification module and the automatic application module. The output integration module is configured to transmit the one or more updated classifications to the one or more external scanning systems and to update a corresponding status of the one or more findings.

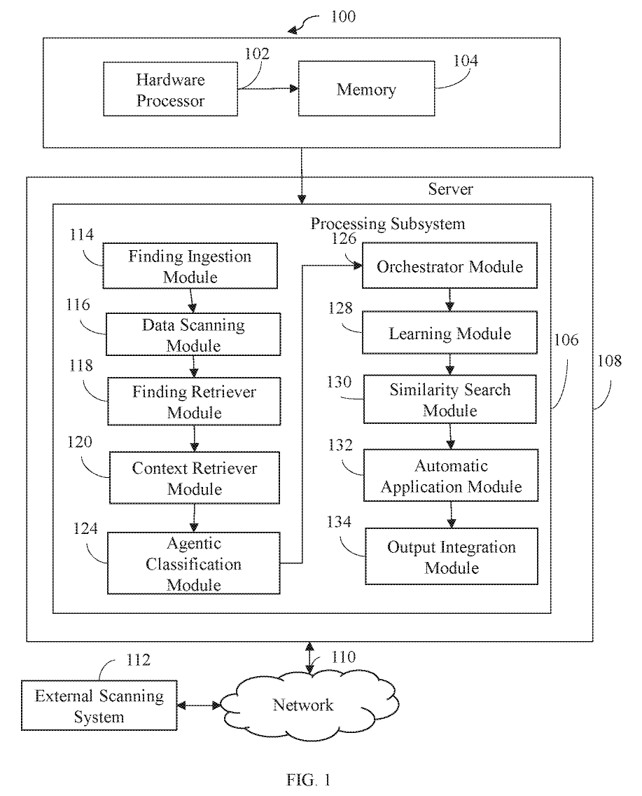

FIG. 1 is a block diagram representation of a system for agentic correction of data classification findings in accordance with an embodiment of the present disclosure. The system 100 includes a hardware processor 102, and a memory 104 coupled to the hardware processor 102. The memory 104 comprises a set of program instructions in the form of a processing subsystem 106 hosted on a server 108. In one embodiment, the server 108 may include a cloud server. In another embodiment, the server 108 may include a local server. The processing subsystem 106 is configured to execute on a network 110 to control bidirectional communications among a plurality of modules. In one embodiment, the network 110 may include a wired network such as a local area network (LAN) or Wide Area Network (WAN), such as the Internet. In another embodiment, the network 110 may include both wired and wireless communications according to one or more standards and/or via one or more transport mediums. In one example, the network 110 may include wireless communications according to one of the 802.11 or Bluetooth specification sets, or another standard or proprietary wireless communication protocol. In yet another embodiment, the network 110 may also include communications over a terrestrial cellular network, including, a global system for mobile communications (GSM), code division multiple access (CDMA), and/or enhanced data for global evolution (EDGE) network.

The system 100 is integrated with one or more external scanning systems 112 to establish a bidirectional communication via an interface. In other words, the system 100 acts as an overlay on the one or more external scanning systems 112. Typically, the one or more external scanning systems 112 are third-party or separate tools that analyse digital data for risks, sensitivity or compliance issues (classification system). Further, the one or more external scanning systems 112 are configured to analyse data sources and generate the plurality of findings based on predefined detection logic, policies, or classification rules. The digital data refers to unstructured files, logs, databases and so on. Further, the digital data may be at an object level (for example, database table or files) or at a level of substrings. This digital data is herein referred to as “findings” in the foregoing discussion. Examples of the one or more external scanning systems includes, but is not limited to, a data loss prevention system detecting a numerical string as a phone number within a document, a data discovery system identifying structured data fields within a database, or a compliance monitoring system flagging data elements associated with regulatory requirements.

The processing subsystem 106 includes a finding ingestion module 114 configured to receive a plurality of findings (data points that require classification) from the one or more external scanning systems 112 via at least one of an application programming interface or a data store. Typically, the plurality of findings refers to the initial classification of data that is performed by the one or more external scanning systems 112. In one embodiment, the plurality of findings may be in the form of alerts. The plurality of findings include data elements, corresponding initial classifications, optional confidence scores, and associated metadata that requires classification review. The data elements represent units of information identified within data sources, including substrings within documents, structured fields within tables, or larger data units, wherein each data element is associated with an initial classification generated by an external scanning system. In one embodiment, the plurality of findings may include, but is not limited to, substrings, structured data fields, or unstructured data segments along with the associated metadata that includes location, context and the confidence scores.

The data store may be configured to receive all or the latest initial findings received by the system 100. In one embodiment, the confidence score may reflect levels of confidence as “low”, “medium” and “high”. In some embodiments, the confidence score may be a number range or categorial indicators. It must be noted that the confidence score is an optional input received from the one or more external scanning systems 112. If a confidence score is available, the system 100 may utilize the confidence score to prioritize evaluation of the findings. For example, findings associated with a “low” confidence score may be considered less likely to contain classification errors, and the confidence score may further be used in determining whether a given classification is correct. Further, in another embodiment, the system 100 may be configured to generate a confidence score, herein referred as, confidence metrics. The associated metadata comprises contextual and structural information corresponding to the data elements, including location, surrounding content, source identifiers, and contextual features that support downstream analysis and classification correction. An example of the metadata may include a substring surrounding the finding.

An example of a finding is as follows:

Text: William’s account is 903-284-2790

Findings: Document: Banking

Sensitive Data: First Name: William

Phone Number: 903-284-2790 < IN ERROR

In the above example, : “903-284-2790” is misclassified as a phone number rather than a bank account.

Other examples of the plurality of findings includes, but is not limited to, a data element representing a numerical string identified within a document, an initial classification indicating a phone number, an associated confidence score indicating medium certainty, and metadata comprising surrounding text indicating a banking context.

Further, the finding ingestion module 114 ensures consistent ingestion of structured data, unstructured data, and semi-structured data generated by the one or more external scanning systems 112, thereby enabling downstream modules to process the plurality of findings in a unified format. The finding ingestion module 114 may further normalize, map, or align classification labels and metadata fields corresponding to the plurality of findings to ensure compatibility with internal data models of the processing subsystem 106.

The processing subsystem 106 includes a data scanning module 116 operatively coupled to the finding ingestion module 114. The data scanning module 116 is configured to identify and classify the data elements of the plurality of findings based on one or more rules or patterns, wherein the data elements comprise substrings within documents, structured fields, or larger data units. The data scanning module 116 processes the plurality of findings received from the finding ingestion module 114 and applies detection logic to recognize patterns, formats, or predefined characteristics associated with the data elements. The one or more rules or patterns may correspond to syntactic structures, numerical formats, keyword associations, or domain-specific indicators that enable classification of the data elements into predefined categories. The data scanning module 116 ensures that each data element within the plurality of findings is assigned a classification label based on evaluation against the one or more rules or patterns, thereby providing a baseline classification for further processing. An example of the data scanning module 116 includes, but is not limited to, applying a pattern corresponding to a numerical format to identify a substring within a document as a phone number or applying a rule corresponding to a keyword context to classify a structured data field as a financial identifier.

Further the data scanning module 116 is configured to classify the data elements using techniques comprising pattern matching, regular expressions, and statistical analysis such that the plurality of findings include the data elements and the associated metadata. The pattern matching enables identification of predefined formats or sequences within the data elements, the regular expressions provide rule-based detection of structured patterns, and the statistical analysis enables probabilistic evaluation of the data elements based on observed characteristics or distributions. The classification process associates each data element with a classification label and corresponding metadata, thereby ensuring that the plurality of findings includes enriched information for downstream processing. An example of classification of the data elements includes, but is not limited to, detecting a numerical substring using regular expressions, validating the pattern using pattern matching, and assigning a classification based on statistical likelihood derived from contextual indicators, along with metadata including position and surrounding context.

In an embodiment, the data elements comprise substrings within documents, structured fields, or larger data units. The substrings represent portions of textual content extracted from documents, the structured fields represent organized entries within tables or databases, and the larger data units represent higher-level entities such as complete records, files, or document sections. Each data element corresponds to a unit of analysis within the plurality of findings and is associated with classification and metadata information for further processing. The inclusion of multiple types of data elements enables comprehensive coverage across different data formats and storage structures. An example of the data elements includes, but is not limited to, a substring representing a numerical sequence within a document, a structured field representing an identifier within a database table, or a larger data unit representing an entire record within a dataset.

The processing subsystem 106 further includes a finding retriever module 118 operatively coupled to the finding ingestion module 114. The finding retriever module is configured to select one or more findings from the plurality of findings based on at least one of the optional confidence scores, classification types, historical error patterns, or predefined selection criteria. The finding retriever module 118 evaluates the plurality of findings received from the finding ingestion module 114 and prioritizes findings that are more likely to require classification correction. The optional confidence scores enable identification of findings with lower confidence, the classification types enable prioritization based on importance of specific categories, the historical error patterns enable identification of recurring misclassification trends, and the predefined selection criteria enable configurable control over selection of findings. The finding retriever module 118 ensures efficient allocation of processing resources by focusing on relevant findings for further analysis. An example of the finding retriever module 118 includes, but is not limited to, selecting findings associated with low confidence scores, selecting findings corresponding to sensitive classification types, or selecting findings matching historical error patterns identified in prior processing.

In an embodiment, the finding retriever module 118 is further configured to filter out the one or more findings that are associated with a pending update and that have been previously updated. The finding retriever module 118 evaluates status information corresponding to the one or more findings to determine whether an update operation is in progress or has already been completed. The filtering operation ensures that the one or more findings that are already subject to update processing or that have undergone prior updates are excluded from further selection, thereby avoiding redundant processing and ensuring efficient utilization of computational resources. The finding retriever module 118 maintains consistency of processing by preventing re-evaluation of findings that do not require additional correction. An example of filtering of the one or more findings includes, but is not limited to, excluding a finding flagged with an update status indicator representing an ongoing update or excluding a finding marked as updated based on application of a previously generated classifier.

In an embodiment, the finding retriever module 118 is further configured to prioritize the one or more findings based on at least one of data type importance or temporal factors. The finding retriever module 118 assigns priority levels to the one or more findings by evaluating significance of classification types associated with the data elements and by considering timing-related attributes corresponding to the one or more findings. The data type importance enables prioritization of findings associated with sensitive or high-impact classification types, while the temporal factors enable prioritization based on recency, update timing, or system latency considerations. The prioritization ensures that the one or more findings that require immediate attention are processed ahead of less critical findings. An example of prioritization of the one or more findings includes, but is not limited to, assigning higher priority to findings associated with sensitive identifiers compared to lower-risk data types or prioritizing recently generated findings over older findings based on temporal relevance.

In an embodiment, a context retriever module 120 is operatively coupled to the finding retriever module 118, wherein the context retriever module 120 is configured to retrieve contextual data corresponding to the one or more findings. The context retriever module 120 accesses data sources associated with the one or more findings to obtain relevant contextual information that supports classification analysis. The contextual data includes information related to surrounding data elements, structural relationships, and related data sources that provide additional insight into characteristics of the one or more findings. The context retriever module 120 ensures that the one or more findings are evaluated not in isolation but in conjunction with relevant contextual information, thereby improving accuracy of classification decisions. An example of the context retriever module 120 includes, but is not limited to, retrieving surrounding text corresponding to a substring within a document, retrieving related fields within a structured dataset, or retrieving similar data elements identified through semantic relationships.

In an embodiment, the contextual data comprises at least one of data elements within a same file, document, table, or structured object, data from related files, tables, or systems, data selected based on similarity using vector embeddings or semantic search, and data selected based on contextual, structural, or feature-based relationships. The context retriever module 120 aggregates the contextual data from multiple sources to provide a comprehensive representation of relationships associated with the one or more findings. The data elements within a same file, document, table, or structured object provide local context, the data from related files, tables, or systems provide broader contextual relationships, the data selected based on similarity using vector embeddings or semantic search provides lookalike context, and the data selected based on contextual, structural, or feature-based relationships provides derived contextual insights. An example of the contextual data includes, but is not limited to, surrounding text within a document, related records within a database table, similar findings identified using vector embeddings, or structurally related fields within a data schema.

In an embodiment, the context retriever module 120 is further configured to retrieve the contextual data using vector-based similarity search corresponding to at least one of content similarity, structural similarity, or contextual similarity. The context retriever module 120 generates or accesses vector representations corresponding to the one or more findings and compares the vector representations with stored vectors to identify similar data elements. The content similarity corresponds to similarity of textual or numerical content, the structural similarity corresponds to similarity of data organization or schema, and the contextual similarity corresponds to similarity of surrounding information or usage patterns. The vector-based similarity search enables efficient identification of relevant contextual data across large datasets. An example of retrieval of the contextual data includes, but is not limited to, identifying data elements with similar textual patterns using vector embeddings, retrieving data elements with similar schema positions, or retrieving data elements with similar surrounding context based on semantic similarity.

In an embodiment, an agentic classification module 124 is operatively coupled to the context retriever module 120, wherein the agentic classification module 124 comprises one or more artificial intelligence and machine learning models comprising at least one large language model, one or more smaller language models, or one or more machine learning models. The agentic classification module 124 utilizes the one or more artificial intelligence and machine learning models to perform contextual reasoning and classification analysis based on the contextual data retrieved by the context retriever module 120. The at least one large language model enables deep semantic understanding and reasoning, the one or more smaller language models enable efficient processing of specific tasks, and the one or more machine learning models enable statistical or predictive classification capabilities. The agentic classification module 124 integrates outputs from the one or more artificial intelligence and machine learning models to generate classification decisions with improved accuracy and adaptability. An example of the agentic classification module 124 includes, but is not limited to, applying a large language model to interpret contextual relationships within text, applying a smaller language model for domain-specific classification, or applying a machine learning model for pattern-based classification.

In an embodiment, the agentic classification module 124 is configured to analyse the one or more findings based on the contextual data. The agentic classification module 124 processes the one or more findings in conjunction with the contextual data retrieved by the context retriever module 120 to derive meaningful relationships and classification insights. The analysis incorporates semantic interpretation, contextual correlation, and feature evaluation of the one or more findings using the one or more artificial intelligence and machine learning models. The contextual data enhances understanding of the one or more findings by providing surrounding information, related data elements, and similarity-based references, thereby enabling accurate and context-aware classification decisions. An example of analysis of the one or more findings includes, but is not limited to, evaluating a numerical data element within a document along with surrounding text indicating a financial context to determine a correct classification.

In an embodiment, the agentic classification module 124 is configured to determine whether an initial classification corresponding to each of the one or more findings is correct, incorrect, or uncertain. The agentic classification module 124 evaluates the initial classification associated with each of the one or more findings by comparing the initial classification with insights derived from the contextual data and outputs of the one or more artificial intelligence and machine learning models. The determination includes identifying agreement between the initial classification and contextual evidence, identifying inconsistencies indicating misclassification, and identifying ambiguity where available information is insufficient to reach a definitive conclusion. The determination enables categorization of the one or more findings into validated classifications, incorrect classifications requiring correction, or uncertain classifications requiring further analysis. An example of determination of the initial classification includes, but is not limited to, identifying a data element initially classified as a phone number as incorrect based on contextual indicators suggesting a financial identifier, or marking a classification as uncertain where contextual evidence is inconclusive.

In an embodiment, the agentic classification module 124 is configured to generate one or more updated classifications corresponding to the one or more findings. The agentic classification module 124 produces the one or more updated classifications based on results of analysis of the one or more findings and the determination of correctness of the initial classification. The one or more updated classifications reflect corrected or refined classification outcomes derived from the contextual data and outputs of the one or more artificial intelligence and machine learning models. The generation of the one or more updated classifications includes assigning appropriate classification labels and may include associated confidence measures or reasoning information. An example of generation of the one or more updated classifications includes, but is not limited to, reclassifying a data element from a phone number classification to a financial identifier classification based on contextual analysis or refining a classification label to a more specific category.

In an embodiment, the agentic classification module 124 is further configured to generate one or more prompts for the at least one large language model based on characteristics associated with the one or more findings and the contextual data. The agentic classification module 124 constructs the one or more prompts by incorporating attributes of the one or more findings, including data element type, classification context, and associated metadata, along with the contextual data retrieved by the context retriever module 120. The one or more prompts are structured to guide the at least one large language model to perform context-aware reasoning and classification analysis, thereby improving relevance and accuracy of model outputs. The generation of the one or more prompts enables dynamic adaptation of input to the at least one large language model based on characteristics of the one or more findings. An example of generation of the one or more prompts includes, but is not limited to, constructing a prompt that includes a data element, surrounding textual context, and classification instructions to determine whether a numerical value represents a financial identifier or another category.

In an embodiment, an orchestrator module 126 is operatively coupled to the finding retriever module 118, the context retriever module 120, and the agentic classification module 124, wherein the orchestrator module 126 is configured to control execution of a plurality of classification stages. The orchestrator module 126 manages sequencing and coordination of processing operations by determining progression of the one or more findings through different classification stages. The plurality of classification stages may correspond to varying levels of computational complexity, contextual depth, and processing techniques, thereby enabling efficient and adaptive classification processing. The orchestrator module 126 ensures that appropriate stage is executed based on characteristics of the one or more findings and available contextual data. An example of control of execution of the plurality of classification stages includes, but is not limited to, initiating a preliminary stage using rule-based processing followed by a subsequent stage using advanced model-based analysis when additional evaluation is required.

In an embodiment, the orchestrator module 126 is configured to route the one or more findings between the plurality of classification stages based on at least one of confidence values associated with the one or more findings or classification characteristics associated with the one or more findings. The orchestrator module 126 evaluates the confidence values derived from the initial classification or generated during processing, and the classification characteristics including data type, contextual complexity, or classification ambiguity, to determine an appropriate classification stage for processing. The routing enables efficient allocation of computational resources by directing straightforward findings to lower-complexity stages and directing complex or uncertain findings to higher-complexity stages. The orchestrator module 126 ensures adaptive processing flow by dynamically selecting suitable classification stages for each of the one or more findings. An example of routing of the one or more findings includes, but is not limited to, directing a finding with high confidence to a lightweight processing stage or directing a finding with low confidence or ambiguous characteristics to an advanced stage utilizing model-based analysis.

In an embodiment, the plurality of classification stages comprise a first stage configured to apply at least one of rule-based processing, statistical methods, and previously generated classifiers. The first stage performs initial evaluation of the one or more findings using lightweight and efficient techniques to rapidly determine classification outcomes for straightforward cases. The rule-based processing applies predefined rules or patterns, the statistical methods evaluate probabilistic characteristics of the data elements, and the previously generated classifiers correspond to classifiers produced by the learning module 128 and applied for high-speed classification. The first stage enables early resolution of the one or more findings that satisfy predefined accuracy conditions, thereby reducing computational load on subsequent stages. An example of the first stage includes, but is not limited to, applying a rule to detect a specific numerical format, applying statistical thresholds to validate classification likelihood, or applying a previously generated classifier to automatically correct similar findings.

In an embodiment, the plurality of classification stages comprise a second stage configured to apply the at least one large language model with additional contextual data. The second stage performs advanced analysis of the one or more findings using deeper contextual understanding and reasoning capabilities of the at least one large language model. The additional contextual data obtained from the context retriever module 120 is incorporated to enhance semantic interpretation, relationship analysis, and classification accuracy. The second stage is utilized for findings that require higher-level reasoning, ambiguity resolution, or validation beyond capabilities of the first stage. The second stage enables generation of refined and accurate classification outcomes by leveraging comprehensive contextual information and model-driven inference. An example of the second stage includes, but is not limited to, applying the at least one large language model to analyse a data element along with surrounding textual context and related data to determine whether the data element corresponds to a financial identifier or another classification category.

In an embodiment, the orchestrator module 126 is further configured to operate in at least one of a fully autonomous mode and a human-guided mode based on at least one of confidence values associated with the one or more updated classifications. The orchestrator module 126 determines an operational mode by evaluating reliability of the one or more updated classifications using the confidence values generated during classification processing. The fully autonomous mode enables automatic processing and application of the one or more updated classifications without human intervention when the confidence values satisfy predefined thresholds, while the human-guided mode enables involvement of a user when the confidence values indicate uncertainty or when classification characteristics require additional validation. The orchestrator module 126 thereby adapts processing behaviour based on reliability and criticality of classification outcomes. An example of operation of the orchestrator module 126 includes, but is not limited to, automatically finalizing a classification when the confidence values exceed a predefined threshold or invoking user input for validation when the confidence values fall below the predefined threshold.

In an embodiment, a learning module 128 is operatively coupled to the agentic classification module 124, wherein the learning module 128 is configured to extract one or more classification patterns from the one or more updated classifications. The learning module 128 analyses the one or more updated classifications generated by the agentic classification module 124 to identify recurring features, relationships, and decision factors that contributed to accurate classification outcomes. The extraction of the one or more classification patterns includes identifying content-based features, contextual indicators, structural relationships, and semantic attributes associated with the one or more findings. The one or more classification patterns represent generalized knowledge derived from corrected classifications that can be reused for future classification tasks. An example of extraction of the one or more classification patterns includes, but is not limited to, identifying a consistent contextual phrase associated with a specific classification type or identifying a semantic pattern within vector representations corresponding to similar findings.

In an embodiment, the learning module 128 is configured to generate at least one targeted classifier or at least one general classifier based on the one or more classification patterns. The learning module 128 utilizes the one or more classification patterns extracted from the one or more updated classifications to construct classifiers that can be applied to future findings for automated classification correction. The at least one targeted classifier is designed to address specific patterns or clusters of similar findings with high precision, while the at least one general classifier is designed to capture broader patterns applicable across diverse data elements and classification types. The generation of the at least one targeted classifier or the at least one general classifier may include creation of vector-based classifiers, rule-based classifiers, statistical models, or hybrid classifiers that combine multiple approaches. An example of generation of the at least one targeted classifier or the at least one general classifier includes, but is not limited to, constructing a classifier based on vector similarity of contextual embeddings corresponding to corrected findings or generating a rule-based classifier derived from consistent contextual features.

In an embodiment, the learning module 128 is configured to identify one or more similar findings based on at least one of similarity search or clustering. The learning module 128 analyses the plurality of findings and corresponding representations to determine relationships between findings that exhibit similar characteristics, contextual features, or structural patterns. The similarity search utilizes vector representations to measure proximity between findings, while the clustering groups findings into clusters based on similarity criteria such as content, context, or classification patterns. The identification of the one or more similar findings enables grouping of related findings for efficient classifier construction and application. An example of identification of the one or more similar findings includes, but is not limited to, retrieving findings with similar contextual embeddings using vector similarity search or grouping findings with similar structural attributes into a cluster for collective analysis.

In an embodiment, the learning module 128 is configured to construct the at least one targeted classifier or the at least one general classifier based on the one or more similar findings. The learning module 128 utilizes the one or more similar findings identified through similarity search or clustering to derive consistent features, contextual relationships, and classification characteristics that define a classifier. The construction of the at least one targeted classifier focuses on specific clusters of the one or more similar findings to achieve high precision, while the construction of the at least one general classifier leverages broader patterns across the one or more similar findings to provide wider applicability. The construction process may include generating vector boundaries, rule sets, statistical models, or hybrid representations that capture defining characteristics of the one or more similar findings. An example of construction of the at least one targeted classifier or the at least one general classifier includes, but is not limited to, forming a vector-based classifier that identifies findings within a defined similarity threshold or constructing a rule-based classifier derived from common contextual attributes across the one or more similar findings.

In an embodiment, a similarity search module 130 is operatively coupled to the learning module 128, wherein the similarity search module 130 comprises a vector database configured to store vector representations corresponding to the plurality of findings, the contextual data, and the at least one targeted classifier or the at least one general classifier. The similarity search module 130 converts the plurality of findings, the contextual data, and the at least one targeted classifier or the at least one general classifier into vector representations that capture semantic, structural, and contextual characteristics. The vector database maintains the vector representations in an indexed format to enable efficient retrieval and comparison operations. The storage of the vector representations enables rapid similarity computation and supports identification of relationships between different data elements and classifiers. An example of storage of the vector representations includes, but is not limited to, storing embedding vectors corresponding to textual content, contextual embeddings derived from surrounding data, and vector representations corresponding to classifier patterns.

In an embodiment, the similarity search module 130 is configured to identify the one or more similar findings based on similarity metrics. The similarity search module 130 evaluates vector representations corresponding to the plurality of findings and compares the vector representations using predefined similarity metrics to determine proximity between findings. The similarity metrics quantify degree of similarity between vector representations based on content characteristics, contextual relationships, or structural attributes. The identification of the one or more similar findings is performed by selecting findings that satisfy similarity thresholds or ranking criteria derived from the similarity metrics. An example of identification of the one or more similar findings includes, but is not limited to, selecting findings with high cosine similarity between embedding vectors or identifying findings within a predefined distance threshold using a similarity metric.

In an embodiment, the system as claimed in claim 1, wherein the similarity search module 130 is configured to perform similarity search using at least one of cosine similarity, Euclidean distance, or other distance metrics. The similarity search module 130 applies the at least one of cosine similarity, Euclidean distance, or other distance metrics to compare vector representations corresponding to the plurality of findings, the contextual data, and the at least one targeted classifier or the at least one general classifier. The cosine similarity measures angular similarity between vectors to capture semantic relationships, the Euclidean distance measures spatial distance between vectors to capture magnitude-based differences, and the other distance metrics provide alternative measures of similarity based on system requirements. The use of the at least one of cosine similarity, Euclidean distance, or other distance metrics enables flexible and accurate identification of similar findings. An example of similarity search using the at least one of cosine similarity, Euclidean distance, or other distance metrics includes, but is not limited to, identifying findings with high cosine similarity in embedding space or selecting findings within a predefined Euclidean distance threshold.

In an embodiment, an automatic application module 132 is operatively coupled to the learning module 128 and the similarity search module 130, wherein the automatic application module 132 is configured to apply the at least one targeted classifier or the at least one general classifier to automatically update classifications of additional findings corresponding to the one or more similar findings. The automatic application module 132 receives the at least one targeted classifier or the at least one general classifier generated by the learning module 128 and identifies the additional findings corresponding to the one or more similar findings using the similarity search module 130. The automatic application module 132 applies the at least one targeted classifier or the at least one general classifier to the additional findings to generate updated classifications without requiring manual intervention. The automatic update ensures that classification corrections are propagated across similar findings efficiently and consistently. An example of application of the at least one targeted classifier or the at least one general classifier includes, but is not limited to, applying a vector-based classifier to reclassify multiple findings with similar contextual embeddings or applying a rule-based classifier to update classifications of findings within a defined cluster.

In an embodiment, an output integration module 134 is operatively coupled to the agentic classification module 124 and the automatic application module 132, wherein the output integration module 134 is configured to transmit the one or more updated classifications to the one or more external scanning systems and to update a corresponding status of the one or more findings. The output integration module 134 communicates the one or more updated classifications generated by the agentic classification module 124 and the automatic application module 132 to the one or more external scanning systems through integration interfaces such as an application programming interface or a data exchange mechanism. The transmission ensures that the classification corrections are reflected in originating systems and enables synchronization between the processing subsystem and the one or more external scanning systems. The output integration module 134 further updates the corresponding status of the one or more findings to indicate classification outcomes, including corrected classifications or resolution states. An example of the output integration module 134 includes, but is not limited to, transmitting a corrected classification for a data element to an external system and updating a status of a finding to indicate resolution of a misclassification.

In an embodiment, the output integration module 134 is further configured to update the corresponding status of the one or more findings by marking the one or more findings as false positives. The output integration module 134 determines that the one or more findings do not correspond to valid classifications based on the one or more updated classifications generated by the agentic classification module 124 or the automatic application module 132. The marking of the one or more findings as false positives indicates that the data elements associated with the one or more findings should not be treated as sensitive or relevant for enforcement actions. The update of the corresponding status ensures that the one or more external scanning systems reflect corrected classification outcomes and avoid unnecessary processing or policy enforcement. An example of updating the corresponding status of the one or more findings includes, but is not limited to, marking a finding initially classified as sensitive data as a false positive when contextual analysis indicates that the data element does not represent sensitive information.

Consider a non-limiting example where the system 100 is deployed within an enterprise data security environment comprising multiple data sources including document repositories, database systems, cloud storage platforms, and communication systems. The system 100 is implemented as an overlay solution integrated with existing data loss prevention systems, data discovery systems, and compliance monitoring systems without requiring modification of the existing infrastructure. The finding ingestion module 114 receives a plurality of findings generated by the one or more external scanning systems, wherein the plurality of findings include data elements such as substrings within documents, structured fields within databases, and unstructured data segments within files, along with corresponding initial classifications, optional confidence scores, and associated metadata. In such environments, the plurality of findings may correspond to sensitive data detected at an object level such as files or database tables or at a substring level within documents, wherein each finding may be associated with enforcement policies such as quarantine or access restriction.

In practical deployments, classification errors are not isolated but occur in clusters, wherein a same type of misclassification is repeated across a large number of similar data elements, thereby creating a large volume of erroneous findings that require correction. Traditional approaches require manual rule tuning, reprocessing of entire datasets, or manual review of large volumes of findings, resulting in significant computational overhead and operational inefficiency. The system 100 addresses such clustered error scenarios by leveraging an agentic classification approach that identifies misclassified findings, retrieves similar findings across datasets, and applies automated correction workflows without requiring rescanning or manual intervention.

In one real-life scenario, the system 100 is deployed in a financial institution that processes large volumes of customer data including account records, transaction logs, and internal documents. The external scanning systems identify sensitive data such as account numbers, phone numbers, and personally identifiable information using rule-based detection methods. However, due to similarity in numerical formats, a plurality of findings corresponding to account numbers may be incorrectly classified as phone numbers. The finding retriever module 118 selects such findings based on low confidence scores and historical error patterns, and the context retriever module 120 retrieves contextual data including surrounding text indicating banking context, related records within database tables, and similar findings identified using vector-based similarity search.

The agentic classification module 124 analyses the one or more findings using the contextual data and determines that the initial classification as phone numbers is incorrect. The agentic classification module 124 generates updated classifications indicating that the data elements correspond to account numbers. The orchestrator module 126 routes the one or more findings through a plurality of classification stages, wherein a first stage may not resolve ambiguity, and a second stage applies a large language model with additional contextual data to produce accurate classification outcomes.

The learning module 128 extracts one or more classification patterns from the one or more updated classifications, such as identifying contextual phrases like “account number” or structural patterns associated with financial identifiers. The learning module 128 generates at least one targeted classifier corresponding to the identified cluster of similar findings. The similarity search module 130 stores vector representations corresponding to the plurality of findings and the contextual data and identifies additional findings with similar characteristics across the enterprise data environment.

From an implementation perspective, the system 100 utilizes vector embedding pipelines to convert the plurality of findings and the contextual data into vector representations, which are indexed within a vector database to enable high-speed similarity search. The orchestrator module 126 coordinates execution by invoking lightweight classifiers in an initial stage and escalating complex findings to large language model-based processing in subsequent stages. The learning module 128 constructs classifiers using embedding boundaries, contextual feature extraction, or hybrid rule-based and machine learning approaches, wherein the classifiers are stored and reused for automatic application. The automatic application module 132 applies the classifiers to similar findings identified through similarity search, thereby enabling batch-level correction without reprocessing entire datasets.

The automatic application module 132 applies the at least one targeted classifier to automatically update classifications of additional findings corresponding to the one or more similar findings, thereby correcting hundreds or thousands of misclassified data elements without manual intervention. The output integration module 134 transmits the one or more updated classifications to the one or more external scanning systems and updates a corresponding status of the one or more findings, including marking incorrect classifications as false positives where applicable.

In another practical scenario, the system 100 identifies a misclassification pattern in a specific document template used across an organization, retrieves similar findings both within and outside an identified cluster using vector similarity, and constructs a targeted classifier using positive and optionally negative examples derived from corrected findings. The targeted classifier is then applied across the enterprise data environment to proactively correct both existing and future findings associated with the pattern, wherein each correction operation may be independently reversible to maintain auditability and control.

In another embodiment, the system 100 is implemented within a healthcare organization to manage sensitive medical data. The external scanning systems may misclassify patient identifiers or medical record numbers due to overlapping patterns with other numerical data. The system 100 identifies such misclassifications, retrieves contextual data such as document type, medical terminology, and related patient records, and applies agentic classification to correct classifications. The learning module 128 generates classifiers that generalize across similar medical datasets, enabling proactive correction of future findings.

It must be noted that the system 100 may be implemented using distributed computing infrastructure, cloud-based services, or on-premises servers depending on organizational requirements. The system 100 may operate in real-time or batch processing modes and may scale to handle large volumes of data across multiple systems. The human-computer interaction module 204 may be invoked in cases where confidence values are below predefined thresholds, allowing domain experts to validate or correct classifications, and the user input is incorporated into the one or more classification patterns for continuous improvement.

It must be further noted that the deployment of the system 100 is not limited to financial or healthcare domains and may be applied across various industries including telecommunications, government, legal, and retail sectors where accurate data classification is critical. The implementation of the system 100 enables reduction of manual effort, improvement of classification accuracy, and scalable correction of classification errors across diverse data environments.

In one embodiment, the various functional components of the computer-implemented system may reside on a single computer, or they may be distributed across several computers in various arrangements. The various components of the computer-implemented system may, furthermore, access one or more databases, and each of the various components of the computer-implemented system may be in communication with one another. Further, while the components of FIG. 1 are discussed in the singular sense, it will be appreciated that in other embodiments multiple instances of the components may be employed.

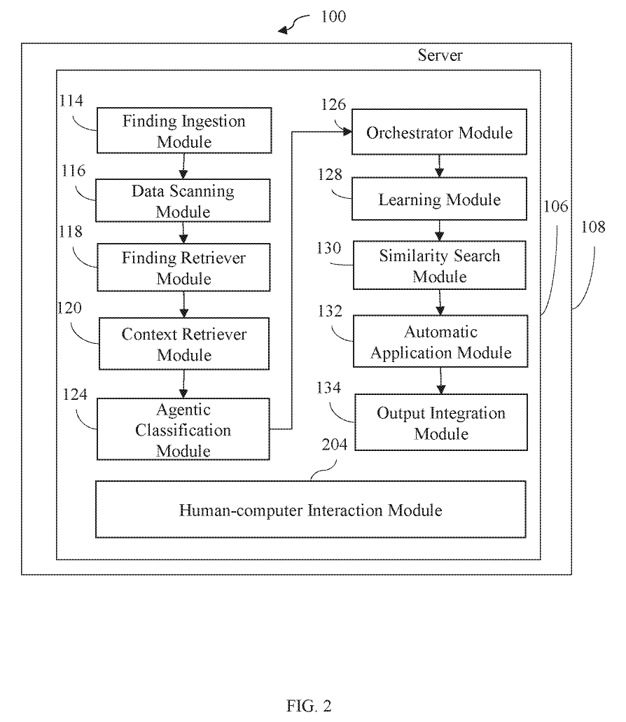

FIG. 2 is a schematic representation of an exemplary embodiment of the system of FIG. 1, in accordance with an embodiment of the present disclosure. The system 100 of FIG. 1 includes a processing subsystem 105 further including a human-computer interaction module 204 . In an embodiment, the system further comprises a human-computer interaction module 204 operatively coupled to the orchestrator module 126, wherein the human-computer interaction module 204 is configured to enable interaction between a user and the processing subsystem for classification guidance and validation. The human-computer interaction module 204 presents the one or more findings along with the contextual data to the user in an interpretable format and allows the user to provide input corresponding to the one or more updated classifications. The human-computer interaction module 204 facilitates incorporation of user input into the classification process, thereby enabling refinement of classification outcomes and supporting supervised or guided operation. An example of the human-computer interaction module 204 includes, but is not limited to, displaying a data element with associated context and receiving user confirmation or correction of a classification label.

In an embodiment, the human-computer interaction module 204 is configured to receive the user input corresponding to the one or more updated classifications. The human-computer interaction module 204 captures user-provided responses that indicate validation, modification, or selection of classification outcomes associated with the one or more findings. The user input corresponds to confirmation of correctness of the one or more updated classifications or correction of the one or more updated classifications based on user expertise and contextual understanding. The received user input is associated with the one or more findings and is utilized for refinement of classification decisions and for subsequent learning processes. An example of receiving the user input includes, but is not limited to, capturing a user selection that confirms a classification label or capturing a user-provided correction that changes a classification label for a data element.

In an embodiment, the human-computer interaction module 204 is configured to incorporate the user input into the one or more classification patterns. The human-computer interaction module 204 forwards the user input corresponding to the one or more updated classifications to the learning module 128, wherein the learning module 128 integrates the user input with the one or more classification patterns extracted from prior updated classifications. The incorporation of the user input enables refinement of the one or more classification patterns by including user-provided corrections, validations, or contextual insights, thereby improving accuracy and adaptability of subsequent classification operations. The incorporation process ensures that human expertise is encoded into reusable classification patterns for future application. An example of incorporation of the user input includes, but is not limited to, updating a classification pattern based on a user correction that identifies a specific contextual indicator associated with a classification type or reinforcing an existing pattern based on user validation of a classification outcome.

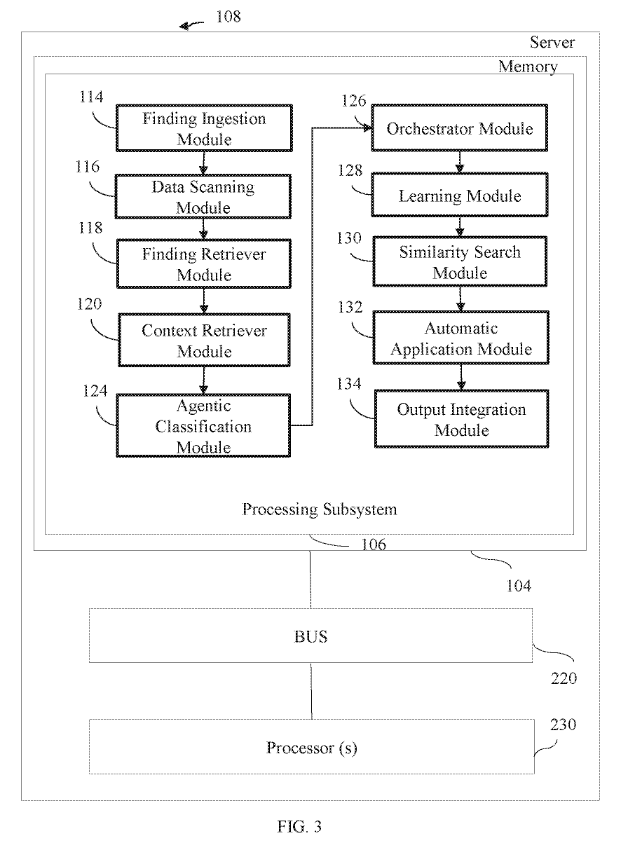

FIG. 3 is a block diagram of a computer or a server 108 in accordance with an embodiment of the present disclosure. The server 108 includes processor(s) 230, and memory 104 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 104 includes several subsystems stored in the form of computer-readable medium which instructs the processor to perform the method steps illustrated in FIG. 1. The memory 104 includes several subsystems stored in the form of executable program which instructs the processor 230 to perform the method steps illustrated in FIG. 1. The memory 104 includes a processing subsystem 106 of FIG. 1. The processing subsystem 106 further has following modules: a finding ingestion module 114, a data scanning module 116, a finding retriever module 118, a context retriever module 120, an agentic classification module 124, an orchestrator module 126, a learning module 128, a similarity search module 130, an automatic application module 132, an output integration module 134, and a human-computer interaction module 204.

A system 100 for agentic correction of data classification findings is provided. The system 100 includes a hardware processor 102, and a memory 104 coupled to the hardware processor 102. The memory 104 comprises a set of program instructions in the form of a processing subsystem 106 hosted on a server 108 and configured to execute on a network 110 to control bidirectional communications among a plurality of modules. The processing subsystem 106 includes a data scanning module 116 operatively coupled to the finding ingestion module 114. The data scanning module 116 is configured to identify and classify the data elements of the plurality of findings based on one or more rules or patterns, wherein the data elements comprise substrings within documents, structured fields, or larger data units. The data scanning module 116 is further configured to classify the data elements using techniques comprising pattern matching, regular expressions, and statistical analysis such that the plurality of findings include the data elements and the associated metadata. The processing subsystem 106 includes a finding retriever module 118 operatively coupled to the finding ingestion module 114. The finding retriever module 118 is configured to select one or more findings from the plurality of findings based on at least one of the optional confidence scores, classification types, historical error patterns, or predefined selection criteria. The finding retriever module 118 is further configured to filter out the one or more findings that are associated with a pending update and that have been previously updated. The processing subsystem 106 includes a context retriever module 120 operatively coupled to the finding retriever module 118. The context retriever module 120 is configured to retrieve contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships. The processing subsystem 106 includes an agentic classification module 124 operatively coupled to the context retriever module 120. The agentic classification module 124 comprises one or more artificial intelligence and machine learning models including at least one large language model, one or more specialized language models, or one or more machine learning models. The agentic classification module 124 is configured to analyse the one or more findings based on the contextual data. The agentic classification module 124 is determine whether an initial classification corresponding to each of the one or more findings is correct, incorrect, or uncertain, and generate one or more updated classifications corresponding to the one or more findings. The processing subsystem 106 includes an orchestrator module 126 operatively coupled to the finding retriever module 118, the context retriever module 120, and the agentic classification module 124. The orchestrator module 126 is configured to control execution of a plurality of classification stages and to route the one or more findings between the plurality of classification stages based on at least one of confidence values associated with the one or more findings or classification characteristics associated with the one or more findings. The processing subsystem 106 includes a learning module 128 operatively coupled to the agentic classification module 124. The learning module 128 is configured to extract one or more classification patterns from the one or more updated classifications, generate at least one targeted classifier or at least one general classifier based on the one or more classification patterns, and identify one or more similar findings based on at least one of similarity search or clustering. The learning module 128 is configured to construct the at least one targeted classifier or the at least one general classifier based on the one or more similar findings. The processing subsystem 106 includes a similarity search module 130 operatively coupled to the learning module 128. The similarity search module 130 comprises a vector database configured to store vector representations corresponding to the plurality of findings, the contextual data, and the at least one targeted classifier or the at least one general classifier. The similarity search module 130 is further configured to identify the one or more similar findings based on similarity metrics. The processing subsystem 106 includes an automatic application module 132 operatively coupled to the learning module 128 and the similarity search module 130. The automatic application module 132 is configured to apply the at least one targeted classifier or the at least one general classifier to automatically update classifications of additional findings corresponding to the one or more similar findings. The processing subsystem 106 includes an output integration module 134 operatively coupled to the agentic classification module 124 and the automatic application module 132. The output integration module 134 is configured to transmit the one or more updated classifications to the one or more external scanning systems and to update a corresponding status of the one or more findings.

While computer-readable medium is shown in an example embodiment to be a single medium, the term “computer-readable medium” should be taken to include a single medium or multiple media (for example, a centralized or distributed database, or associated caches and servers) able to store the instructions. The term “computer readable medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

The bus 220 as used herein refers to be internal memory channels or computer network that is used to connect computer components and transfer data between them. The bus 220 includes a serial bus or a parallel bus, wherein the serial bus transmits data in bit-serial format, and the parallel bus transmits data across multiple wires. The bus 220 as used herein may include but not limited to, a system bus, an internal bus, an external bus, an expansion bus, a frontside bus, a backside bus, and the like.

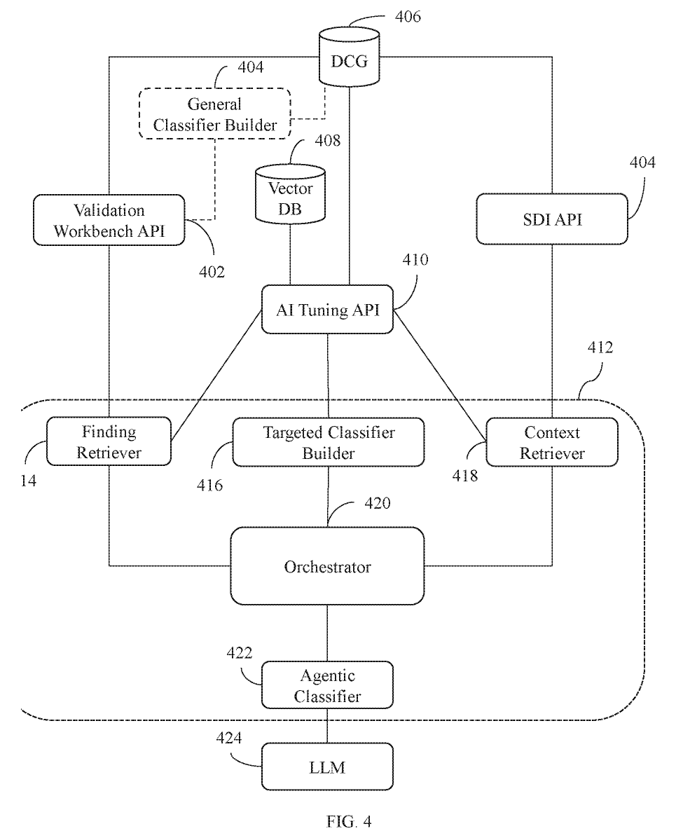

FIG. 4 is a schematic diagram illustrating an operational flow and integration of the system of FIG. 1 with external systems, in accordance with an embodiment of the present disclosure. The system 100 comprises a validation workbench application programming interface (API) 402, an SDI API 404, a data/decision graph (DCG) 406, a vector database 408, and an AI tuning API 410 operatively coupled to an agentic tuner module 412.

The agentic tuner 412 orchestrates the entire classification tuning process. The agentic tuner 412 coordinates between several workflows, services and learning modules. The agentic tuner 412 is configured to track the system 100 to ensure reliable operation. The system 100 may be in “ready”, “busy” or “error” states. It must be noted the agentic tuner 412 is configured with the two-tier processing approach.

The agentic tuner 412 includes the finding retriever 414, targeted classifier builder 416, context retriever 418, orchestrator 420 and agentic classifier 422. The finding retriever 414 is configured to fetch findings for analysis based on criteria such as cluster size, classification importance or confidence scores. It can also determine the cluster size and relationships among findings. The targeted classifier builder 416 is configured to refine specific classifiers for clusters of the findings. Further, the targeted classifier builder 416 outputs the updated findings and new or improved classifiers. The context retriever 418 gathers contextual information including neighbour findings, structural relationships and lookalike findings identified through vector similarity search. The orchestrator 420 coordinates the overall workflow by passing the findings and context to an agentic classifier. The agentic classifier 422 uses a LLM 424 to analyse the information and determine an updated classification. Successful corrections are returned to the orchestrator and passed to the targeted classifier builder. The targeted classifier builder 416 constructs reusable classifiers capable of resolving similar findings automatically.

The agentic tuner 412 also integrates with the vector database 408 for similarity search and may interact with broader data stores or graph systems that maintain metadata and relationships across the system.

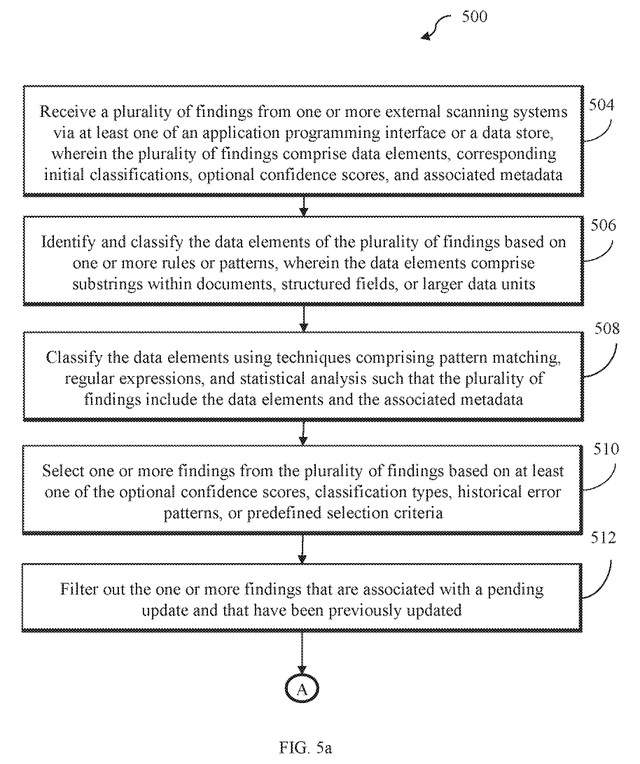

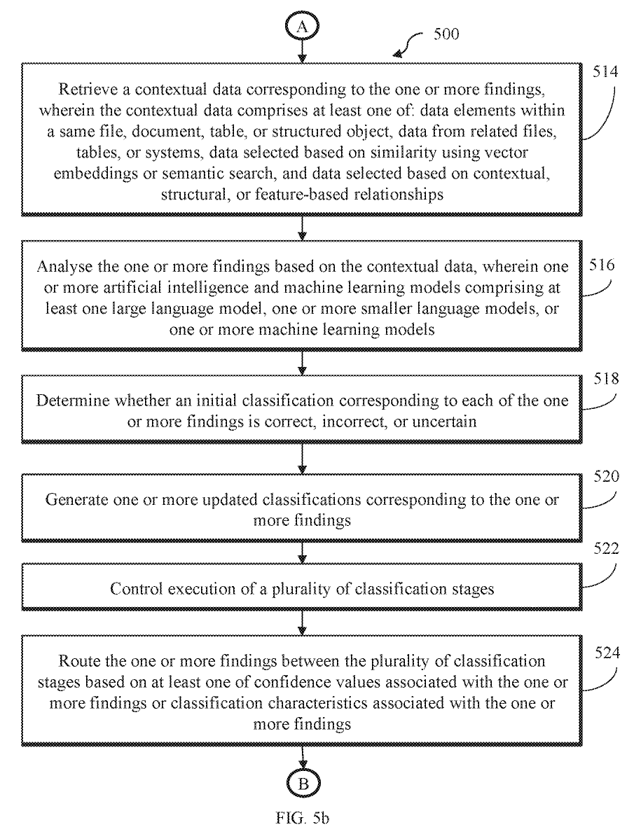

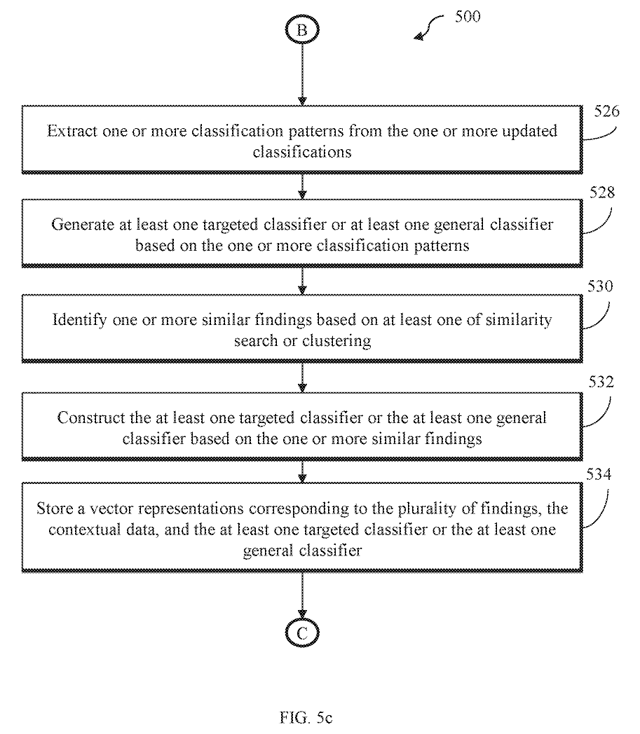

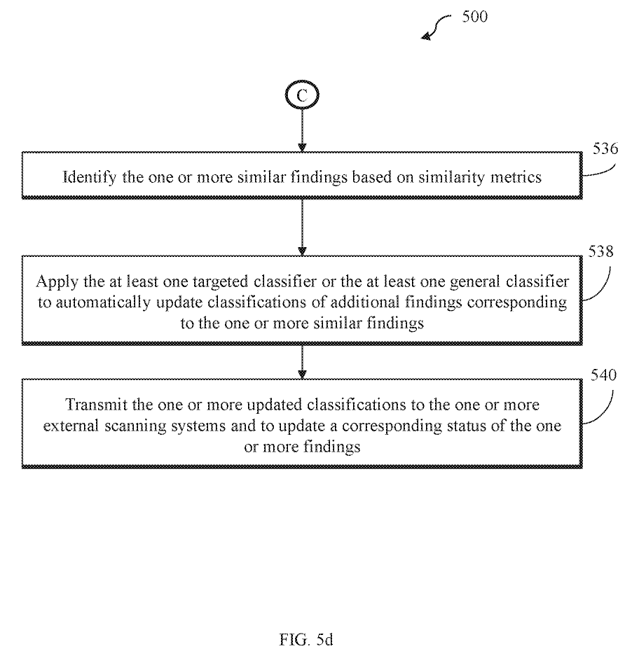

FIG. 5a is a flow chart representing the steps involved in a method for agentic correction of data classification findings in accordance with an embodiment of the present disclosure. FIG. 5b is a flow chart representing the continued steps involved in a method of FIG. 5a, in accordance with an embodiment of the present disclosure. FIG. 5c is a flow chart representing the continued steps involved in a method of FIG. 5b, in accordance with an embodiment of the present disclosure. FIG. 5d is a flow chart representing the continued steps involved in a method of FIG. 5c, in accordance with an embodiment of the present disclosure. The method 500 begins at step 504.

At step 504, receiving a plurality of findings from one or more external scanning systems via at least one of an application programming interface or a data store, wherein the plurality of findings comprise data elements, corresponding initial classifications, optional confidence scores, and associated metadata. In one embodiment, the one or more external scanning systems comprise at least one of data loss prevention systems, data discovery systems, and compliance monitoring systems.

The plurality of findings comprise substrings, structured data fields, or unstructured data segments along with the associated metadata including location, context, and classification confidence.

At step 506, identifying and classifying the data elements of the plurality of findings based on one or more rules or patterns, wherein the data elements comprise substrings within documents, structured fields, or larger data units. The rules or patterns may include predefined rules, learned patterns or classification signatures derived from earlier training.

In one embodiment, the one or more findings are prioritized based on at least one of data type importance or temporal factors. Some types of data are inherently more critical or sensitive. Findings involving such data are given higher priority. For instance, highly sensitive data includes financial records and personal identifiers. Less sensitive data includes generic or public information. This ensures that high-risk or high-impact findings are handled first. Similarly, temporal factors refers to priority influenced by time-related aspects. For example, more recent findings may be prioritized over older ones or time-sensitive incidents (e.g., potential data breach) may be handled urgently.

At step 508, classifying the data elements using techniques comprising pattern matching, regular expressions, and statistical analysis such that the plurality of findings include the data elements and the associated metadata. Through these techniques, appropriate classifications are determined for the data elements with improved accuracy and consistency. Further, as a result of this classification, each of the plurality of findings is structured to include the data elements themselves, and the corresponding associated metadata (e.g., contextual attributes, source information, or classification-related data). Accordingly, the findings are not only classified using multiple complementary techniques, but also organized in a manner that preserves both the underlying data and its contextual information for downstream processing.

At step 510, selecting one or more findings from the plurality of findings based on at least one of the optional confidence scores, classification types, historical error patterns, or predefined selection criteria. Typically, this step describes a selective filtering stage, wherein a subset of findings is chosen for further processing based on defined evaluation parameters. Findings associated with lower confidence scores may be preferentially selected for review or reclassification, as such findings are more likely to contain inaccuracies. Further, findings belonging to particular categories (e.g., sensitive or high-risk classifications) may be prioritized for further analysis. Furthermore, findings that correspond to patterns or conditions previously associated with misclassification may be selected to improve accuracy. Additionally, configurable rules or thresholds (e.g., policy-driven filters, domain-specific conditions, or user-defined parameters) may be applied to identify relevant findings. Accordingly, step 308 enables intelligent prioritization and selection, ensuring that downstream processing resources are focused on findings with higher relevance, risk, or likelihood of classification error.

In one embodiment, a fully autonomous mode or a human-guided mode is enabled based on at least one of confidence values associated with the one or more updated classifications.

At step 512, filtering out the one or more findings that are associated with a pending update and that have been previously updated. A finding associated with a pending update may correspond to a finding for which an update operation (e.g., reclassification or metadata modification) has been initiated but not yet completed. A previously updated finding may correspond to a finding that has already undergone modification or refinement in an earlier iteration. By removing such findings, the system avoids duplicate processing, conflicting updates, and unnecessary computational overhead. This ensures that subsequent processing is performed only on findings that require evaluation or modification.

At step 514, retrieving a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships.

The contextual data may include data elements located within the same file, document, table, or structured object as the finding, thereby providing local context, data obtained from related files, tables, or external systems, enabling broader contextual understanding, data identified using vector embeddings and/or semantic search techniques, wherein semantically similar or related data elements are retrieved based on similarity metrics or data selected based on contextual, structural, or feature-based relationships, including associations defined by data schemas, linkages, or inferred correlations. The retrieval of such contextual data enables the method to augment the findings with additional relevant information, thereby improving the robustness and accuracy of subsequent classification, validation, or refinement operations.

In one embodiment, the contextual data is retrieved using vector-based similarity search corresponding to at least one of content similarity, structural similarity, or contextual similarity.

In another embodiment, one or more prompts are generated for the at least one large language model based on characteristics associated with the one or more findings and the contextual data.

At step 516, analysing the one or more findings based on the contextual data, wherein one or more artificial intelligence and machine learning models comprising at least one large language model, one or more specialized language models, or one or more machine learning models. The analysis leverages one or more models configured to process the findings and associated context to generate refined classifications, validations, or insights. Typically, the said models identifies relationships and patterns, evaluates the correctness of existing classifications and generates updated or refined classifications outputs.

At step 518, determining whether an initial classification corresponding to each of the one or more findings is correct, incorrect, or uncertain. A correct classification indicates that the initial classification is consistent with the analysis and requires no modification. An incorrect classification indicates that the initial classification is inconsistent with the analysis and requires correction or reclassification. Likewise, an uncertain classification indicates that the method lacks sufficient confidence or supporting information to conclusively determine correctness. The determination may be based on factors including model outputs, confidence scores, pattern matching results, and contextual consistency.

At step 520, generating one or more updated classifications corresponding to the one or more findings. In one embodiment, the classifications may include multiple stages. For instance, a first stage configured to apply at least one of rule-based processing, statistical methods, and previously generated classifiers and a second stage configured to apply the at least one large language model with additional contextual data.

The multi-stage approach enables the system to combine the efficiency and consistency of rule-based and statistical techniques with the contextual understanding and adaptability of advanced AI models.

At step 522, controlling execution of a plurality of classification stage. The control may include initiating, sequencing, coordinating, and conditionally invoking the plurality of classification stages. By controlling execution in this manner, the method enables adaptive and efficient classification, ensuring that appropriate processing stages are applied based on the characteristics of the findings and intermediate outcomes.

At step 524, routing the one or more findings between the plurality of classification stages based on at least one of confidence values associated with the one or more findings or classification characteristics associated with the one or more findings. The confidence values may indicate a degree of certainty associated with a current or prior classification, and may be used to determine whether additional processing is required. For example, findings associated with lower confidence values may be routed to more advanced or computationally intensive classification stages, while findings associated with higher confidence values may bypass such stages.

The classification characteristics may include attributes such as classification type, sensitivity level, data format, or detected patterns. These characteristics may be used to direct findings to specialized classification stages tailored to particular data types or use cases. By enabling such routing, the system ensures that each finding is processed using appropriate and efficient classification pathways, thereby optimizing resource utilization and improving classification accuracy.

At step 526, extracting one or more classification patterns from the one or more updated classifications. The classification patterns may represent recurring rules, features, relationships, or decision factors that contributed to the generation of the updated classifications. The extraction process may involve identifying commonalities across multiple updated classifications, thereby generalizing individual classification decisions into reusable patterns.

At step 528, generating at least one targeted classifier or at least one general classifier based on the one or more classification patterns. A targeted classifier is configured to operate on a specific subset of findings, such as a particular data type, cluster, or use case. Such classifiers are typically optimized for high precision within a narrowly defined scope, leveraging patterns that are specific to that subset. A general classifier, in contrast, is configured to operate across a broader range of findings, applying more generalized patterns to support wider applicability, potentially with lower specialization.

At step 530, identifying one or more similar findings based on at least one of similarity search or clustering. In various embodiments, similarity search may include comparing vector representations (e.g., embeddings) of findings to determine semantic or feature-based similarity. Findings having similarity values exceeding a predefined threshold may be identified as similar. Additionally, or alternatively, clustering may be performed to group findings into clusters based on shared characteristics, patterns, or relationships. Each cluster may represent a set of findings exhibiting similar attributes or classification-relevant features. The similarity determination may be based on one or more factors, data element characteristics, contextual data, metadata attributes and previously derived classification patterns.

At step 532, constructing the at least one targeted classifier or the at least one general classifier based on the one or more similar findings. The similar findings provide a coherent training or rule derivation set, as they share common characteristics, patterns, or contextual relationships. By leveraging similar findings, the system ensures that the constructed classifiers are contextually consistent and pattern-driven, thereby improving classification accuracy and robustness.

At step 534, storing a vector representations corresponding to the plurality of findings, the contextual data, and the at least one targeted classifier or the at least one general classifier. The vector representations may comprise numerical embeddings that encode semantic, structural, and/or feature-based characteristics of the corresponding data. Such embeddings enable efficient similarity search, clustering, and retrieval operations. The vector representations may be stored in a vector database or similar data structure configured for high-dimensional indexing and retrieval.

At step 536, identifying the one or more similar findings based on similarity metrics. In one embodiment, the similarity search is performed using at least one of cosine similarity, Euclidean distance, or other distance metrics. The similarity metrics provide a numerical measure of how closely related two or more findings are in terms of their features, content, or contextual attributes.

At step 538, applying the at least one targeted classifier or the at least one general classifier to automatically update classifications of additional findings corresponding to the one or more similar findings. The “additional findings” may include newly received findings or previously unprocessed findings that have been identified as similar based on similarity search, clustering, or similarity metrics. By leveraging this similarity, the system can extend learned classification logic to these related findings.

At step 540, transmitting the one or more updated classifications to the one or more external scanning systems and to update a corresponding status of the one or more findings. The transmission may be performed via one or more communication interfaces, including application programming interfaces (APIs) or data exchange mechanisms. In addition to transmitting the updated classifications, the system is further configured to update a corresponding status of the one or more findings. The status may indicate, for example: that the finding has been processed or reclassified, whether the classification has been confirmed, corrected, or remains uncertain, or the completion state of the processing workflow.

In one embodiment, the corresponding status of the one or more findings are updated by marking the one or more findings as false positives.

In one embodiment, the one or more findings and the contextual data is presented to a user. In such an embodiment, the user input is received corresponding to the one or more updated classifications. Subsequently, the user input is incorporated into the one or more classification patterns.

The method 500 ends at step 540.

Various embodiments of the system and method for agentic correction of data classification findings described above enable various advantages. The system comprising the processing subsystem 106 provides several technical advantages including revolutionary operational efficiency, advanced artificial intelligence-driven accuracy, improved user interaction, and seamless enterprise integration. The processing subsystem 106, through the agentic classification module 124, the learning module 128, and the automatic application module 132, eliminates the need for manual detector maintenance by avoiding manual rule updates, regex modifications, or detector reconfiguration. Further, the system avoids rescanning of source data by applying learned classification patterns directly to existing and future findings, thereby reducing computational overhead. The system is compatible with a plurality of external scanning systems via the finding ingestion module 114 and the output integration module 134, enabling universal deployment without requiring modification of existing infrastructure. Additionally, each classification correction is generalized by the learning module 128 and applied at scale using the similarity search module 130, thereby resolving a plurality of similar findings automatically and improving operational efficiency without continuous human intervention. The processing subsystem 106 enhances classification accuracy by leveraging advanced artificial intelligence models within the agentic classification module 124, which perform contextual and semantic analysis beyond rule-based techniques. The learning module 128 enables intelligent pattern recognition by extracting and generalizing classification patterns, thereby enabling continuous self-improvement of the system over time. Further, the similarity search module 130 facilitates cross-system intelligence by identifying similar findings across different data sources, ensuring consistent classification across the entire data ecosystem. The orchestrator module 126 enables confidence-based routing of findings across multiple classification stages, thereby ensuring reliable and accurate classification outcomes. The system improves user experience through the human-computer interaction module 204, which enables intuitive interaction using natural language inputs and provides contextual visualization of findings and related data. The system supports flexible interaction modes, allowing users to validate, guide, or review classifications based on expertise levels. Further, the processing subsystem 106 enables proactive resolution of future findings by applying learned classifiers, thereby reducing manual intervention and enabling scalable human impact wherein a single correction can resolve a plurality of similar cases. The system 100 enables seamless enterprise integration by operating as an overlay on existing scanning infrastructure through the finding ingestion module 114 and the output integration module 134, thereby preserving existing system investments. The system provides immediate improvements in classification accuracy without requiring system replacement and supports integration with multiple external systems including data loss prevention systems, data discovery systems, and compliance monitoring systems. Additionally, the modular architecture of the processing subsystem 106, including the orchestrator module 126 and the learning module 128, enables adaptability to evolving artificial intelligence technologies and classification methodologies, thereby providing a future-proof solution.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for agentic correction of data classification findings, comprising:
a hardware processor; and
a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules comprising:
a finding ingestion module configured to receive a plurality of findings from one or more external scanning systems via at least one of an application programming interface or a data store, wherein the plurality of findings comprise data elements, corresponding initial classifications, optional confidence scores, and associated metadata;
a data scanning module operatively coupled to the finding ingestion module, wherein the data scanning module is configured to:
identify and classify the data elements of the plurality of findings based on one or more rules or patterns, wherein the data elements comprise substrings within documents, structured fields, or larger data units; and
classify the data elements using techniques comprising pattern matching, regular expressions, and statistical analysis such that the plurality of findings include the data elements and the associated metadata;
a finding retriever module operatively coupled to the finding ingestion module, wherein the finding retriever module is configured to:
select one or more findings from the plurality of findings based on at least one of the optional confidence scores, classification types, historical error patterns, or predefined selection criteria; and
filter out the one or more findings that are associated with a pending update and that have been previously updated;
a context retriever module operatively coupled to the finding retriever module, wherein the context retriever module is configured to retrieve a contextual data corresponding to the one or more findings, wherein the contextual data comprises at least one of:
data elements within a same file, document, table, or structured object,
data from related files, tables, or systems, data selected based on similarity using vector embeddings or semantic search, and
data selected based on contextual, structural, or feature-based relationships;
an agentic classification module operatively coupled to the context retriever module, wherein the agentic classification module comprises at least one of a large language model, specialized language model and machine learning model, and wherein the agentic classification module is configured to:
analyse the one or more findings based on the contextual data; determine whether an initial classification corresponding to each of the one or more findings is correct, incorrect, or uncertain; and
generate one or more updated classifications corresponding to the one or more findings;
an orchestrator module operatively coupled to the finding retriever module, the context retriever module, and the agentic classification module, wherein the orchestrator module is configured to:
control execution of a plurality of classification stages; and
route the one or more findings between the plurality of classification stages based on at least one of confidence values associated with the one or more findings or classification characteristics associated with the one or more finding;
a learning module operatively coupled to the agentic classification module, wherein the learning module is configured to:
extract one or more classification patterns from the one or more updated classifications;
generate at least one targeted classifier or at least one general classifier based on the one or more classification patterns;
identify one or more similar findings based on at least one of similarity search or clustering; and
construct the at least one targeted classifier or the at least one general classifier based on the one or more similar findings;
a similarity search module operatively coupled to the learning module, wherein the similarity search module comprises a vector database configured to:
store a vector representations corresponding to the plurality of findings, the contextual data, and the at least one targeted classifier or the at least one general classifier; and
identify the one or more similar findings based on similarity metrics;
an automatic application module operatively coupled to the learning module and the similarity search module, wherein the automatic application module is configured to apply the at least one targeted classifier or the at least one general classifier to automatically update classifications of additional findings corresponding to the one or more similar findings; and
an output integration module operatively coupled to the agentic classification module and the automatic application module, wherein the output integration module is configured to:
transmit the one or more updated classifications to the one or more external scanning systems and to update a corresponding status of the one or more findings.

2. The system of claim 1, wherein the plurality of findings comprise substrings, structured data fields, or unstructured data segments along with the associated metadata including location, context, and classification confidence.

3. The system of claim 1, wherein the one or more external scanning systems comprise at least one of data loss prevention systems, data discovery systems, and compliance monitoring systems.

4. The system of claim 1, wherein the context retriever module is further configured to retrieve the contextual data using vector-based similarity search corresponding to at least one of content similarity, structural similarity, or contextual similarity.

5. The system of claim 1, wherein the plurality of classification stages comprise:
a first stage configured to apply at least one of rule-based processing, statistical methods, and previously generated classifiers;
a second stage configured to apply the at least one large language model with additional contextual data.

6. The system of claim 1, wherein the similarity search module is configured to perform similarity search using at least one of cosine similarity, Euclidean distance, or other distance metrics.

7. The system of claim 1, wherein the agentic classification module is further configured to generate one or more prompts for the at least one large language model based on characteristics associated with the one or more findings and the contextual data.

8. The system of claim 1, further comprising a human-computer interaction module operatively coupled to the orchestrator module, wherein the human-computer interaction module is configured to:
present the one or more findings and the contextual data to a user;
receive the user input corresponding to the one or more updated classifications; and
incorporate the user input into the one or more classification patterns.

9. The system of claim 1, wherein the finding retriever module is further configured to prioritize the one or more findings based on at least one of data type importance or temporal factors.

10. The system of claim 1, wherein the output integration module is further configured to update the corresponding status of the one or more findings by marking the one or more findings as false positives.

11. The system of claim 1, wherein the orchestrator module is further configured to operate in at least one of a fully autonomous mode and a human-guided mode based on at least one of confidence values associated with the one or more updated classifications.

12. The system of claim 1, wherein the agentic classification module is configured to be trained using the plurality of findings to refine subsequent classifications.

13. A method for agentic correction of data classification findings, comprising:
receiving a plurality of findings from one or more external scanning systems via at least one of an application programming interface or a data store, wherein the plurality of findings comprise data elements, corresponding initial classifications, optional confidence scores, and associated metadata;
identifying and classifying the data elements of the plurality of findings based on one or more rules or patterns, wherein the data elements comprise substrings within documents, structured fields, or larger data units;
classifying the data elements using techniques comprising pattern matching, regular expressions, and statistical analysis such that the plurality of findings include the data elements and the associated metadata;
selecting one or more findings from the plurality of findings based on at least one of the optional confidence scores, classification types, historical error patterns, or predefined selection criteria;
filtering out the one or more findings that are associated with a pending update and that have been previously updated;
retrieving a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships;
analysing the one or more findings based on the contextual data, wherein one or more artificial intelligence and machine learning models comprising at least one large language model, one or more specialized language models, or one or more machine learning models;
determining whether an initial classification corresponding to each of the one or more findings is correct, incorrect, or uncertain;
generating one or more updated classifications corresponding to the one or more findings;
controlling execution of a plurality of classification stages;
routing the one or more findings between the plurality of classification stages based on at least one of confidence values associated with the one or more findings or classification characteristics associated with the one or more findings;
extracting one or more classification patterns from the one or more updated classifications;
generating at least one targeted classifier or at least one general classifier based on the one or more classification patterns;
identifying one or more similar findings based on at least one of similarity search or clustering;
constructing the at least one targeted classifier or the at least one general classifier based on the one or more similar findings;
storing a vector representations corresponding to the plurality of findings, the contextual data, and the at least one targeted classifier or the at least one general classifier;
identifying the one or more similar findings based on similarity metrics;
applying the at least one targeted classifier or the at least one general classifier to automatically update classifications of additional findings corresponding to the one or more similar findings; and
transmitting the one or more updated classifications to the one or more external scanning systems and to update a corresponding status of the one or more findings.

14. A non-transitory computer-readable medium storing a computer program that, when executed by a processor, causes the processor to perform a method for agentic correction of data classification findings, comprising:
receiving a plurality of findings from one or more external scanning systems via at least one of an application programming interface or a data store, wherein the plurality of findings comprise data elements, corresponding initial classifications, optional confidence scores, and associated metadata;
identifying and classifying the data elements of the plurality of findings based on one or more rules or patterns, wherein the data elements comprise substrings within documents, structured fields, or larger data units;
classifying the data elements using techniques comprising pattern matching, regular expressions, and statistical analysis such that the plurality of findings include the data elements and the associated metadata;
selecting one or more findings from the plurality of findings based on at least one of the optional confidence scores, classification types, historical error patterns, or predefined selection criteria;
filtering out the one or more findings that are associated with a pending update and that have been previously updated;
retrieving a contextual data corresponding to the one or more findings, wherein the contextual data comprises at least one of: data elements within a same file, document, table, or structured object, data from related files, tables, or systems, data selected based on similarity using vector embeddings or semantic search, and data selected based on contextual, structural, or feature-based relationships;
analysing the one or more findings based on the contextual data, wherein one or more artificial intelligence and machine learning models comprising at least one large language model, one or more specialized language models, or one or more machine learning models;
determining whether an initial classification corresponding to each of the one or more findings is correct, incorrect, or uncertain;
generating one or more updated classifications corresponding to the one or more findings;
controlling execution of a plurality of classification stages;
routing the one or more findings between the plurality of classification stages based on at least one of confidence values associated with the one or more findings or classification characteristics associated with the one or more findings;
extracting one or more classification patterns from the one or more updated classifications;
generating at least one targeted classifier or at least one general classifier based on the one or more classification patterns;
identifying one or more similar findings based on at least one of similarity search or clustering;
constructing the at least one targeted classifier or the at least one general classifier based on the one or more similar findings;
storing a vector representations corresponding to the plurality of findings, the contextual data, and the at least one targeted classifier or the at least one general classifier;
identifying the one or more similar findings based on similarity metrics;
applying the at least one targeted classifier or the at least one general classifier to automatically update classifications of additional findings corresponding to the one or more similar findings; and
transmitting the one or more updated classifications to the one or more external scanning systems and to update a corresponding status of the one or more findings.
